(19) United States
(12) Patent Application Publication
(10) Pub. No.: US 2013/0119268 A1
(43) Pub. Date: May 16, 2013

(54) METHOD AND APPARATUS FOR CURING THE COATING OF A COMPONENT BY MEANS OF FREE RADICALS GENERATED BY ULTRAVIOLET (UV) RADIATION

(71) Applicant: Marco Tenes Iturri, Lezo (Gipuzkoa) (ES)

(72) Inventor: Marco Tenes Iturri, Lezo (Gipuzkoa) (ES)

(73) Assignee: LIFITEC S.L.U., LEZO (ES)

(21) Appl. No.: 13/812,798

(22) PCT Filed: Jul. 28, 2011
(86) PCT No.: PCT/ES11/00244

§ 371 Date: Jan. 28, 2013

(30) Foreign Application Priority Data
Jul. 29, 2010 (ES) P201000991

(51) Int. Cl. B05C 9/12

(52) U.S. Cl. CPC B05C 9/12
USPC 250/453.11

(57) ABSTRACT

Apparatus for curing the coating of a workpiece (1) by means of UV radiation, which is provided with at least one tank (2) of inert gas heavier than air and into which the workpiece (1) is inserted. The apparatus comprises a plenum (3) adjacent to the tank (2), into which inert gas is injected to supply the tank (2) and from which inert gas is injected towards the interior of the tank (2). Between the plenum (3) and the tank (2) there is an intermediate exchange wall (4)that only allows the inert gas to pass towards the tank (2) when a certain level of pressure is exceeded inside the plenum (3). The invention thus allows inert gas to be supplied to the interior of the tank (2) without causing instability or turbulence in it.

### TECHNICAL FIELD

The invention relates to a method and apparatus for curing the coating of a workpiece with free radicals generated by means of ultraviolet (UV) radiation.

### PRIOR ART

Curing by ultraviolet (UV) radiation is a widely used technique for drying or curing certain types of liquid coatings, which turns them into solid dry compounds almost immediately. This type of curing is used in various industrial and even domestic applications, e.g. to produce immediate curing of dyes, varnishes, adhesives and paint. This curing technique is based on projecting UV radiation on a workpiece or a substrate provided with a coating or finish; said coating is in the form of a liquid composition that comprises a mixture of oligomers (polymers with a low molecular weight), monomers, additives and pigments, as well as compounds known as photoinitiators, which absorb UV radiation and generate free radicals. When the UV radiation reaches the coating, the photoinitiators cause the aforementioned generation of free radicals, which also cause the cross-linking (formation of a type of three-dimensional network) of the oligomers contained in the composition of the coating, with the subsequent formation a dry final coating layer.

It is known that performing UV-radiation curing in an atmospheric environment containing air is not satisfactory, due to the fact that oxygen in the air inhibits the reactivity of the composition of the coating. There are known proposals to address this problem, such as the one presented in EP1235652, in which curing is carried out by the radiation of sunlight or UV lamps in an environment or atmosphere mainly consisting of a heavy gas (preferably CO₂), with a low oxygen content. As a result, the presence of oxygen and its negative influence on the curing is reduced. A later document US20080003372 is also known. in which a method and apparatus for free-radical UV-radiation curing is described, with the particularity that the curing is implemented by immersing the substrate provided with the coating in a tank inside containing an inert gas atmosphere (preferably CO₂). Immersion takes place at a depth where the concentration of oxygen is sufficiently low and constant. Once the substrate is immersed, UV radiation is applied on the substrate to cure its coating. Once the coating is dry, the substrate is extracted from the inert gas atmosphere. UV radiation is applied from UV-radiation sources situated on the exterior of the tank, the UV radiation passing through a window located on the wall of the tank.

A problem common to the various known apparatus, including the one described in US20080003372, is that UV-radiation emitting lamps give off heat in the form of infrared (IR) radiation, which is transmitted to the inert gas atmosphere and causes instability in the system. This problem arises in the case of US20080003372, in which a two-dimensional, horizontally disposed substrate or workpiece is cured, as the gas level must only be kept constant up to a relatively low height (mark 1.4.2), later being disposed with a distance up to a greater height (mark 1.4.1) in order to disperse the turbulence in the gas. However, apparatus designed to cure three-dimensional workpieces or workpieces of a certain height would have to be excessively high in order to function in the same way as the apparatus in US20080003372, i.e. to enable the dispersal of turbulence in the gas situated on top of the workpiece. Evidently, such apparatus are not feasible. As a result, in apparatus for curing three-dimensional workpieces, which cannot be excessively large, the instability in the inert gas atmosphere would result in gas leaking from the apparatus, meaning that more inert gas would have to be injected into the apparatus to maintain stability. Consequently, the apparatus would consume an excessive amount of gas.

A possible solution to the problem of preventing turbulence caused by IR radiation inside a curing apparatus is to place the UV-radiation sources at a certain distance from the apparatus. However, this solution is not deemed useful from a technical standpoint as it may result in the unit formed by the apparatus and the UV-radiation sources being excessively large. In addition, more powerful UV-radiation sources would have to be used in this case, impacting negatively on the consumption of the apparatus.

The objective of the invention is to provide an apparatus for curing coatings that are formed by compositions that may be cured by means of free radicals generated by UV radiation, where the heating of the interior of the tank is reduced as far as is possible, preventing turbulence in the inert gas atmosphere, with, in other words, a stable system being obtained. Specifically, the invention aims to improve the manner in which inert gas is supplied inside the tank, with the result that the supply is provided in the most stable manner possible.

### BRIEF DESCRIPTION OF THE INVENTION

It is an object of this invention to provide an apparatus for the curing of the coating of a workpiece, where said coating is formed by a free radical UV-radiation curable composition. As other conventional apparatus, the apparatus comprises at least one tank that contains inert gas heavier than air and into which the workpiece is inserted, and at least one UV-radiation source that generates the radiation that falls on the workpiece to cure its coating. Additionally, the apparatus of the invention comprises a plenum adjacent to the tank, into which inert gas is injected to supply the tank and from which inert gas is injected towards the interior of the tank. An intermediate exchange wall is disposed between the plenum and the tank to allow the inert gas to pass from the plenum to the tank when the inert gas exceeds a certain level of pressure inside the plenum. This technical feature allows a constant pressure to be achieved inside the plenum prior to the transfer of the gas to the tank, and as a result of which the gas is diffused uniformly across the entire intermediate exchange wall towards the tank, without high-speed points. In consequence, inert gas is supplied to the interior of the tank without this supply causing instability or turbulence in the inert gas atmosphere of said interior of the tank.

### BRIEF DESCRIPTION OF THE DRAWINGS

Details of the invention can be seen in the accompanying non-limiting drawings:

FIG. 1 shows a schematic cross-sectional view of an embodiment of the inventive apparatus.

### DETAILED DESCRIPTION OF THE INVENTION

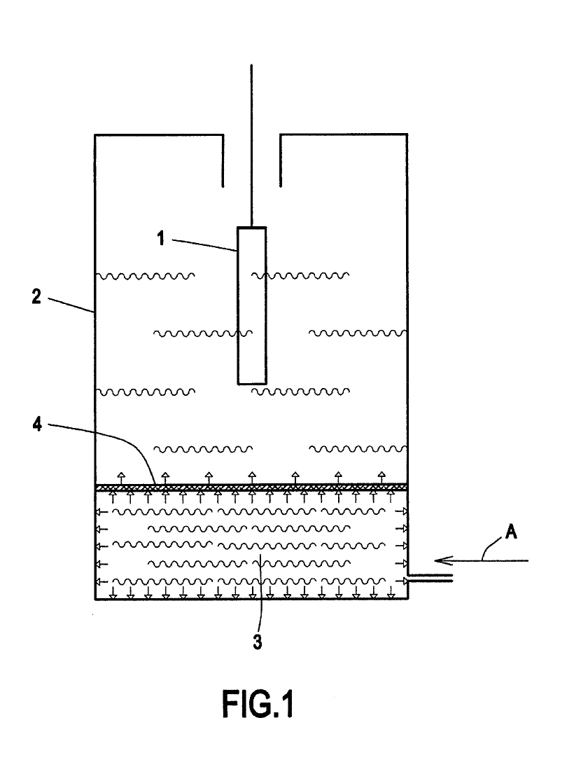

FIG. 1 shows an embodiment of the apparatus for curing a workpiece (1) provided with a coating formed by a composition that may be cured by means of free radicals generated by UV radiation. The inventive apparatus comprises at least one tank (2), which contains inert gas heavier than air and into which the workpiece (1) is inserted, and at least one UV-radiation source (not shown in the figures) that generates radiation that projects on the workpiece (1) to cure its coating. The apparatus of the invention comprises a plenum (3) or chamber where the inert gas has a lower pressure than it does in the tank (2), said plenum (3) being disposed adjacent to the tank (2). Said plenum (3) receives the injection of inert gas in order to supply the tank (2) and it is from said plenum (3) that inert gas is injected towards the interior of the tank (2). The injection of inert gas into the plenum (3) is indicated in the figure by the arrow (A); the proceedings of the injected inert gas (e.g. recirculated inert gas coming from the tank (2) itself, external inert gas, or any other applicable variant) is not relevant to this invention.

An intermediate exchange wall (4) is disposed between the plenum (3) and the tank (2), said intermediate exchange wall (4) allowing the inert gas to pass through from the plenum (3) to the tank (2) when the inert gas exceeds a certain pressure inside the plenum (3). This ensures that the inert gas is injected into the tank (2) through the intermediate exchange wall (4) in a homogeneous manner, without high-speed injection points, thereby preventing the formation of turbulence or currents as a result of the injection of inert gas. This also enables the consumption of inert gas by the apparatus to be kept at reasonable levels.

Preferably, as shown in the figure, the plenum (3) is disposed beneath the tank (2), with the result that the intermediate exchange wall (4) is in the top part of the plenum (3) and in the bottom part of the tank (2). This is deemed an optimal arrangement because, as the inert gas is a gas heavier than air, it allows both the tank (2) to be filled in a more uniform manner and the level of inert gas inside the tank (2) to be more precisely controlled. The advantage of injecting the inert gas into the bottom part of the tank (2) is that it simplifies and clarifies the design of the gas inlet and outlet of the tank (2), and it also separates the inlet of gases from the outlet of gases, preventing the formation of loops.

By way of example, the intermediate exchange wall (4) may be manufactured with a synthetic compound of intertwined fibres of increasing density, with a head loss (loss of pressure through the intermediate exchange wall (4)) of 250 Pa. This is merely an example and other widely differing embodiments of the intermediate exchange wall (4) may also be envisaged.

1. Apparatus for curing the coating of a workpiece (1), where said coating is made of a composition that may be cured by means of free radicals generated by ultraviolet (UV) radiation, where the apparatus comprises at least one tank (2)that contains inert gas heavier than air and into which the workpiece (1) is inserted, and at least one UV-radiation source (3) that generates radiation that falls on the workpiece (1) to cure its coating, characterised in that it comprises:
a plenum (3) adjacent to the tank (2), into which inert gas for the supply of the tank (2) is injected and from which inert gas is injected towards the interior of the tank (2), an intermediate exchange wall (4) being disposed between the plenum (3) and the tank (2), wherein
the intermediate exchange wall (4) is such that it allows the inert gas to pass through the plenum (3) towards the tank (2) when the inert gas exceeds a certain pressure in the interior of the plenum (3).

2. Apparatus according to claim 1, characterised in that it the plenum (3) is disposed beneath the tank (2), and in that the intermediate exchange wall (4) is located in the top part of the plenum (3) and in the bottom part of the tank (2).

3. Apparatus according to claim 1, characterised in that it the intermediate exchange wall (4) is made of at least one synthetic compound of intertwined fibres of increasing density, with a head loss of approximately 250 Pa.
